(19) United States
(12) Patent Application Publication
(10) Pub. No.: US 2011/0045810 A1
(43) Pub. Date: Feb. 24, 2011

(54) SEMANTIC CALLBACK TRIGGERS FOR AN ELECTRONIC DOCUMENT

(75) Inventors: Alfredo C. Issa, Apex, NC (US); Richard J. Walsh, Raleigh, NC (US)

Correspondence Address: WITHROW & TERRANOVA, P.L.L.C., 100 REGENCY FOREST DRIVE, SUITE 160, CARY, NC, 27518, US

(73) Assignee: OTO TECHNOLOGIES, LLC, Raleigh, NC (US)

(21) Appl. No.: 12/544,260

(22) Filed: Aug. 20, 2009

(51) Int. Cl. H04M 3/00

(52) U.S. Cl. 455/418

(57) ABSTRACT

Systems and methods relating to callback triggers for mobile or electronic documents are provided. In general, a callback trigger defines a triggering event and a callback action to be performed in response to an occurrence of the triggering event during consumption of the electronic document by an end user. As such, when the triggering event defined by a callback trigger is detected during consumption of the electronic document by an end user, a corresponding callback action is performed. In one embodiment, the one or more callback triggers for the electronic document include at least one semantic callback trigger.

### RELATED APPLICATIONS

The present application is related to commonly assigned U.S. patent application Ser. No. ______, filed ______, entitled “ELECTRONIC DOCUMENT CALLBACK TRIGGERS”; Ser. No. ______, filed ______, entitled “DYNAMIC CALLBACK TRIGGERS FOR AN ELECTRONIC DOCUMENT”; and Ser. No. ______, filed ______, entitled “ELECTRONIC DOCUMENT CALLBACK TRIGGER CREATION,” which are hereby incorporated herein by reference in their entireties.

### FIELD OF THE DISCLOSURE

The present disclosure relates to electronic documents, and specifically relates to callback triggers for electronic documents.

### BACKGROUND

In today's digital world, electronic documents are shared or otherwise distributed from a number of sources. For example, electronic documents are becoming increasingly popular with the success of devices such as the Amazon Kindle e-reader. There is a desire to leverage the success of such devices to enhance the experience of end users while reading electronic documents and to provide information to creators and/or distributors of the electronic documents with respect to utilization of the electronic documents by end users.

### SUMMARY OF THE DETAILED DESCRIPTION

Systems and methods relating to callback triggers for mobile or electronic documents are provided. In general, a callback trigger defines a triggering event and a callback action to be performed in response to an occurrence of the triggering event during consumption of the electronic document by an end user. As such, when the triggering event defined by a callback trigger is detected during consumption of the electronic document by an end user, a corresponding callback action is performed. For example, the callback action may be sending a text message or e-mail message to an entity such as a creator of the electronic document or a creator of the callback trigger, establishing voice communication with an entity such as the creator of the electronic document or the creator of the callback trigger, presenting the end user with one or more questions and returning corresponding answers provided to the end user to an entity such as a creator of the electronic document or the creator of the callback trigger, or the like.

In one embodiment, one or more callback triggers for the electronic document include at least one customized callback trigger. More specifically, the end user obtains the electronic document and one or more callback triggers for the electronic document. The one or more callback triggers are customized based on one or more criteria such as information regarding the end user such as demographic information regarding the end user or information identifying the end user as a member of a known group of users, a location of the end user, a current time of day, a current date, one or more current events, or any combination thereof. The one or more callback triggers may additionally or alternatively be customized based on historical information regarding the end user such as, for example, past electronic documents read by the end user, past purchases made by the end user, or the like. Thereafter, when a triggering event for one of the callback triggers is detected during consumption of the electronic document by the end user, a corresponding customized callback action is performed.

In another embodiment, the one or more callback triggers for the electronic document include at least one dynamic callback trigger. More specifically, the end user obtains an electronic document and one or more callback triggers for the electronic document. The at least one dynamic callback trigger is updated over time. For example, the at least one dynamic callback trigger may be updated periodically, each time the electronic document is opened, or in response to a change in a criterion on which the dynamic callback trigger depends (e.g., location, date, time, etc.).

In yet another embodiment, the one or more callback triggers for the electronic document include at least one semantic callback trigger. A semantic callback trigger is a trigger that occurs at a point in the electronic document that satisfies one or more semantic criteria. Either prior to consumption by the end user or during consumption by the end user, the electronic document is analyzed to identify a point in the electronic document that satisfies the one or more semantic criteria. When a triggering event for the semantic callback trigger is detected during consumption of the electronic document by the end user, a corresponding callback action is performed.

Those skilled in the art will appreciate the scope of the present invention and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the invention, and together with the description serve to explain the principles of the invention.

FIG. 1 illustrates a system for providing callback triggers for electronic documents according to a first embodiment of the present disclosure;

FIG. 2 illustrates the operation of the system of FIG. 1 according to one embodiment of the present disclosure;

FIG. 3 illustrates the operation of the system of FIG. 1 according to another embodiment of the present disclosure;

FIG. 4 illustrates a system for providing callback triggers for electronic documents according to a second embodiment of the present disclosure;

FIG. 5 illustrates the operation of the system of FIG. 4 according to one embodiment of the present disclosure;

FIG. 6 illustrates a system for providing callback triggers for electronic documents according to a third embodiment of the present disclosure;

FIG. 7 illustrates the operation of the system of FIG. 6 according to one embodiment of the present disclosure;

FIG. 8 illustrates a system for providing callback triggers for electronic documents according to a fourth embodiment of the present disclosure;

FIG. 9 illustrates the operation of the system of FIG. 8 according to one embodiment of the present disclosure;

FIG. 10 is a block diagram of the central system of FIGS. 1-9 according to one embodiment of the present disclosure;

FIG. 11 is a block diagram of the user device of the creator of the callback triggers in the system of FIG. 1 according to one embodiment of the present disclosure; and

FIG. 12 is a block diagram of the user device of the end user in the systems of FIGS. 1, 4, 6, and 8 according to one embodiment of the present disclosure.

### DETAILED DESCRIPTION

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

Systems and methods relating to callback triggers for mobile or electronic documents are provided. As used herein, an electronic document is a document in electronic format. Exemplary electronic documents include, but are not limited to, books, magazines, articles, web pages, e-mail messages, text messages, blogs, or the like. It should be noted that while the discussion herein focuses on electronic documents, the systems and methods described herein may also be used to provide and utilize callback triggers for media items such as, for example, audio content items such as audio books, podcasts, or the like, and/or video content items such as video clips, movies, television programs, or the like.

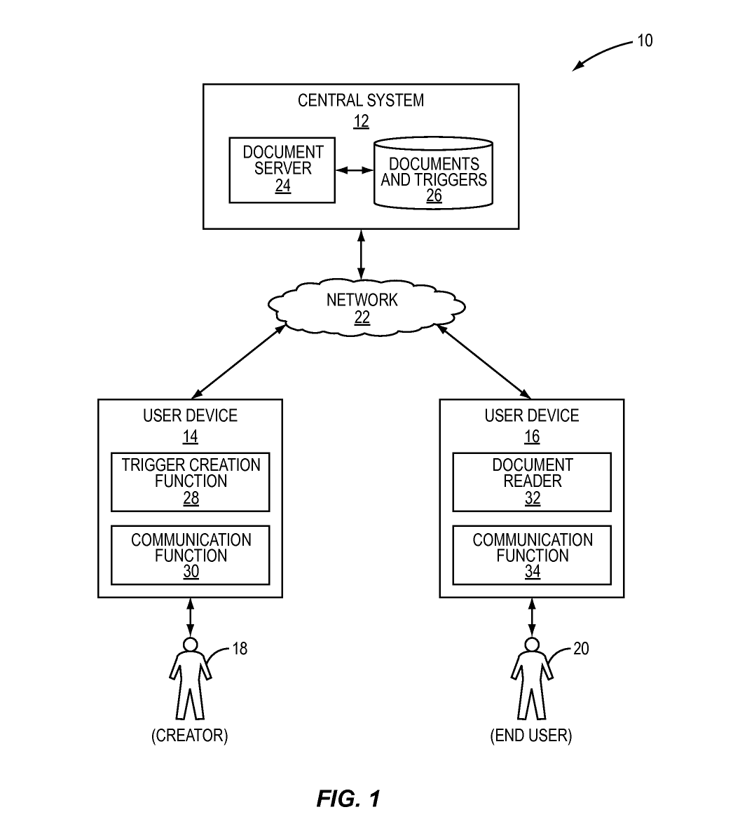

FIG. 1 illustrates a system 10 for providing callback triggers for electronic documents according to one embodiment of the present disclosure. As illustrated, the system 10 includes a central system 12 and user devices 14 and 16 having users 18 and 20, respectively. The central system 12 is communicatively coupled to the user devices 14 and 16 via a network 22. The network 22 may be any type of wired network, any type of wireless network, or any combination thereof. As one example, the network 22 is a public, distributed network such as the Internet, where the user devices 14 and 16 are connected to the network 22 via wired or wireless network connections.

The central system 12 is implemented as one or more physical servers hosting a document server 24 and a collection of documents and callback triggers (hereinafter referred to as “triggers) 26. The document server 24 is preferably implemented in software, but may be implemented in software, hardware, or a combination thereof. In this embodiment, the document server 24 operates to serve electronic documents and their corresponding triggers from the collection of documents and triggers 26 to user devices, such as the user device 16, upon request. The collection of documents and triggers 26 includes a number of electronic documents and one or more triggers for at least some of the electronic documents. The one or more triggers for an electronic document may be stored internally within the electronic document such as, for example, within headers of a corresponding digital file or embedded within a body of the electronic document within the corresponding digital file. Alternatively, the one or more triggers for an electronic document may be stored in an associated, but separate, file such as an application file.

The user device 14 is a mobile or stationary device. Generally, the user device 14 is any type of personal device having computing capabilities such as, for example, a personal computer, a notebook computer, an e-book reader (e.g., an Amazon Kindle), a mobile smart phone (e.g., an Apple iPhone), a Personal Digital Assistant (PDA), a gaming console (e.g., a PlayStation 3), a mobile gaming device (e.g., a PlayStation Portable or Apple iPod Touch), or the like. The user device 14 includes a trigger creation function 28 and a communication function 30. The trigger creation function 28 is preferably implemented in software, but may be implemented in software, hardware, or a combination thereof. Further, when implemented in software, the trigger creation function 28 may be a proprietary software application or a component of a proprietary software application. Alternatively, the trigger creation function 28 may be provided at the user device 14 via a web browser in communication with the document server 24, wherein the document server 24 enables trigger creation via the web browser. In operation, the trigger creation function 28 creates triggers for electronic documents either based on manual input from the user 18 or automatically based on one or more rules. The trigger creation function 28 provides the triggers for the electronic documents and, in some embodiments, the electronic documents to the document server 24 for storage in the collection of documents and triggers 26. The communication function 30 is an application or component that enables communication via text messaging, e-mail, voice communication, or the like. The communication function 30 may be implemented in software, hardware, or a combination thereof. For example, the communication function 30 may be an e-mail application, a text messaging function such as, for example, a Short Message Service (SMS) or Multimedia Messaging Service (MMS) application, a cellular telecommunications interface enabling voice communication, or the like.

In a similar manner, the user device 16 is a mobile or stationary device. Generally, the user device 16 is any type of personal device having computing capabilities such as, for example, a personal computer, a notebook computer, an e-book reader (e.g., an Amazon Kindle), a mobile smart phone (e.g., an Apple iPhone), a PDA, a gaming console (e.g., a PlayStation 3), a mobile gaming device (e.g., a PlayStation Portable or Apple iPod Touch), or the like. The user device 16 includes an electronic document reader function 32 (hereinafter “document reader function 32”) and a communication function 34.

The document reader function 32 is preferably implemented in software, but may be implemented in software, hardware, or a combination thereof. Further, when implemented in software, the document reader function 32 may be a proprietary software application or a component of a proprietary software application. Alternatively, the document reader function 32 may be provided via a web browser in communication with the document server 24, wherein the document server 24 enables consumption (e.g., reading, viewing, etc.) of electronic documents via the web browser. In operation, the document reader function 32 enables the user 20 to view, or otherwise consume, electronic documents. As discussed below in detail, while the user 20 is consuming an electronic document, the document reader function 32 operates to detect triggering events for one or more corresponding triggers provided for the electronic document. In response to detecting a triggering event during consumption of the electronic document, the document reader function 32 performs a callback action defined by the trigger. The communication function 34 is an application or component that enables communication via text messaging, e-mail, voice communication, or the like. The communication function 34 may be implemented in software, hardware, or a combination thereof. For example, the communication function 34 may be an e-mail application, a text messaging function such as, for example, a SMS or MMS application, a cellular telecommunications interface enabling voice communication, or the like.

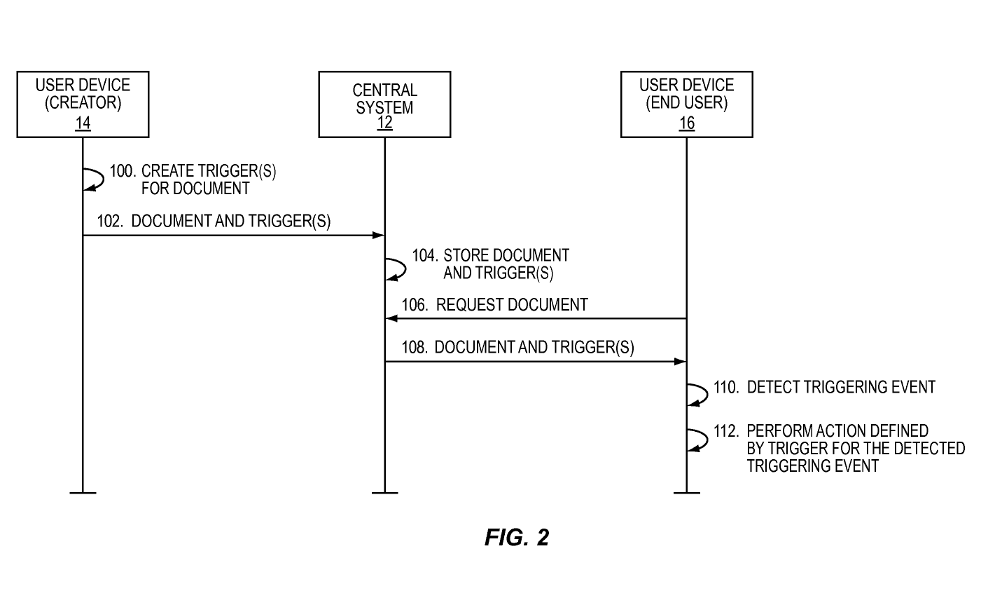

FIG. 2 illustrates the operation of the system 10 of FIG. 1 according to one embodiment of the present disclosure. As illustrated, first, one or more triggers for an electronic document are created at the user device 14 (step 100). The electronic document may be an electronic document that is also created by the user 18 or a pre-existing electronic document. In this embodiment, each trigger created for the electronic document defines a triggering event and a callback action to be performed in response to the triggering event. Preferably, the callback action for a trigger is one or more of the following: sending a text message to a defined entity, sending an e-mail message to a defined entity, establishing voice communication with a defined entity, and polling the end user or asking the end user a number of questions and returning answers provided by the end user to a defined entity. Note that the callback action may provide information to the defined entity in receipt of the resulting communication regarding the end user, the trigger or triggering event, the electronic document, or any combination thereof. For example, if the callback action is sending an e-mail message, the e-mail message may include an identifier of the end user (e.g., name), contact information for the end user (e.g., e-mail address or phone number), demographic information regarding the end user, a geographic location of the end user, information identifying or describing the trigger and/or triggering event, information identifying the electronic document, information identifying a location of the end user within the electronic document, or the like, or any combination thereof.

Note that, in one embodiment, the callback action may be utilized as a form of rights management for the electronic document. For instance, the creator or publisher of the electronic document may grant rights permitting access to the electronic document based on triggers. For example, the end user may not be able to continue consuming the electronic document (e.g., may not be able to advance to the next page) unless the callback action for a corresponding trigger is performed to send a message to a defined entity and a response is received from the defined entity.

The triggering event for a trigger may be defined in different manners depending on the particular trigger. In one embodiment, the triggering event for a trigger is defined by a trigger point and a user action. The trigger point may be a particular area of the electronic document such as a chapter, a section, a heading, a paragraph, a sentence, a word, a phrase, a picture, a figure, or any combination thereof. Alternatively, the trigger point may be defined by one or more semantic criteria such that a point within the electronic document satisfying the one or more semantic criteria is identified as the trigger point for the trigger. The user action may be scrolling past the trigger point; tapping, clicking, or otherwise selecting the trigger point; dwelling on the trigger point for a defined amount of time; gazing at the trigger point; or the like. For example, if the electronic document is a user manual for a product, a trigger for the electronic document may provide that if the end user dwells on a particular section of the user manual regarding a particular feature of the product for more than a specified amount of time (triggering event), then a mobile telecommunications call is to be established between the end user and a customer service representative with knowledge regarding that particular feature of the product (callback action).

In another embodiment, the triggering event for a trigger may be highlighting or otherwise selecting text, a picture, a figure, or any combination thereof within the electronic document by the end user. For example, if the electronic document is a user manual for a particular product, the trigger may provide that, if the user highlights a portion of the electronic document (e.g., text, a picture, and/or a figure), an e-mail message including the highlighted portion of the electronic document and requesting assistance is to be sent to a customer service representative. As another example, the callback action may depend on the specific highlighted, or user selected, portion of the electronic document. For instance, if the electronic document is a user manual for a particular product, the trigger may provide that, if the end user highlights a portion of the electronic document (e.g., text, a picture, and/or a figure), an e-mail message including the highlighted portion of the electronic document and requesting assistance is to be sent to a customer service representative, where the particular customer service representative to which the e-mail is sent is a function of the particular portion of the electronic document that has been highlighted or otherwise selected by the end user.

The triggering event for each of the one or more triggers for the electronic document may be further defined by one or more additional criteria. The one or more additional criteria may include, for example, one or more time or date criteria, one or more user-based criteria, one or more location-based criteria, or any combination thereof. In this manner, the triggers can be customized for end users, locations, and/or dates or times. For instance, a triggering event may be defined as the occurrence of a defined user action at a defined trigger point during a defined time of day (e.g., 7 pm-10 pm) or on a date within a defined range of dates (e.g., December 1-December 31). As another example, a triggering event may be defined as the occurrence of a defined user action at a defined trigger point for an end user satisfying one or more user-based criteria. The one or more user-based criteria may include, for instance, one or more demographic based criteria (e.g., end user age being in range of 30-40 years old), one or more criteria specifying that the end user is part of a defined group of users (e.g., end user is in Teacher A's English Literature Class at School B), or one or more criteria specifying that the end user must be within a defined distance from the creator or publisher of the electronic document or the creator of the trigger in a social network (e.g., within 2 degrees of separation). As another example, a triggering event may be defined as the occurrence of a defined user action at a defined trigger point for an end user located within a defined geographic area (e.g., end user located in Raleigh, N.C.).

The manner in which the one or more triggers are created for the electronic document may vary depending on the particular implementation. In general, the one or more triggers may be created manually or automatically. More specifically, in one embodiment, the user 18 provides input to the trigger creation function 28 of the user device 14 to manually define the one or more triggers for the electronic document, in which case the user 18 is referred to as the creator of the one or more triggers. Note that while in this embodiment the user 18 creates one or more triggers for a specific electronic document, in another embodiment, the user 18 may create one or more triggers to be applied to all electronic documents or defined groups of electronic documents. The defined groups of electronic documents may be defined by one or more criteria such as, for example, topic, date of publication or creation, author or creator, or the like.

In another embodiment, the trigger creation function 28 generates one or more triggers for the electronic document automatically based on one or more rules. The one or more rules include one or more system-defined rules, one or more user-defined rules, or both. The one or more system-defined rules are not defined by the user 18 whereas the one or more user-defined rules are defined by the user 18. The one or more rules enable the trigger creation function 28 to identify points in the electronic document for which triggers are to be created and define callback actions for the triggers. For example, the one or more rules may indicate that a trigger is to be inserted for each section of the electronic document, that the triggers are to be activated as an end user scrolls past the corresponding sections, and that an e-mail message is to be sent to the user 18 each time the triggers are activated. The e-mail message may notify the user 18 that an end user or a particular end user has just read or is currently reading the corresponding section of the electronic document. As another example, the one or more rules may indicate that a trigger is to be inserted for an occurrence or for each occurrence of a specified word or phrase within the electronic document, that the trigger(s) are to be activated when an end user clicks, taps, or otherwise selects the specified word or phrase, and that a mobile telecommunications call be established between the end user and a specified entity when the trigger is activated. As a final example, the one or more rules may include a semantic rule indicating that a trigger is to be inserted at an occurrence or at each occurrence of content within the electronic document satisfying one or more semantic criteria. For instance, the specified semantic criteria may include a criterion of “action” such that the electronic document is processed to identify words, sentences, paragraphs, or the like in which substantial action is taking place (e.g., an action scene) and insert triggers at those points to send text messages to the creator of the electronic document upon activation of those triggers. Similarly, the specified semantic criteria may include a criterion of “Cuban Cuisine” such that the electronic document is processed to identify words, sentences, paragraphs, or the like related to Cuban cuisine and insert triggers to contact a reservation service if an end user gazes upon those points in the electronic document for more than a specified amount of time.

Once the triggers are created for the electronic document, in this embodiment, the trigger creation function 28 of the user device 14 sends the electronic document and the one or more triggers for the electronic document to the document server 24 of the central system 12 (step 102). The one or more triggers may be inserted within the electronic document. For example, the one or more triggers may be inserted in headers of the digital file for the electronic document or embedded within the body of the electronic document within the digital file. In another embodiment, the one or more triggers may be separate from the electronic document. For example, the one or more triggers may be maintained in an application file and associated with the electronic document. Upon receiving the electronic document and the one or more triggers for the electronic document, the document server 24 of the central system 12 stores the electronic document and the one or more triggers for the electronic document in the collection of documents and triggers 26 (step 104).

Some time thereafter, the document server 24 of the central system 12 receives a request for the electronic document from the user device 16 (step 106). In response, the document server 24 of the central system 12 returns the electronic document and the one or more triggers for the electronic document to the user device 16 (step 108). Note that, in some embodiments, the one or more triggers for the electronic document may include triggers having triggering events that are further defined by additional criteria such as one or more user-based criteria regarding the end user, one or more location-based criteria regarding the location of the end user, one or more time or date based criteria, or any combination thereof. In this case, the document server 24 of the central system 12 may return all triggers for the electronic document to the user device 16 or return only those triggers relevant to the user 20, the location of the user 20, and/or the current time or date. For instance, the one or more triggers for the electronic document may include different sets of triggers for different groups of users, which may be defined by the user-based criteria for the corresponding triggering events. As such, the document server 24 of the central system 12 may identify the set of triggers for the electronic document for a group of users of which the user 20 is a member and return one or more of the identified set of triggers to the user device 16. In a similar manner, sets of triggers may be defined for different geographic areas, different times of the day, and/or different ranges of dates, where the one or more triggers returned to the user device 16 are triggers from the relevant sets of triggers for the electronic document. In another embodiment, the user 20 may subscribe to triggers for one or more identified users, and the document server 24 may return triggers for the electronic document created by those identified users.

User preferences of the user 20 may be used to filter triggers for the electronic document. The filtering may occur at the document server 24 or at the user device 16. For example, the user 20 may define user preferences indicating that the user 20 does not permit defined types of triggers such as triggers having undesired triggering events or undesired callback actions (e.g., callback action to an undesired entity). Also note that, in some embodiments, the user 20 may be enabled to opt out of triggers by, for example, paying certain fees.

The document reader function 32 of the user device 16 then presents the electronic document to the user 20 (which is also referred to as the end user). During presentation of the electronic document to the user 20 and, therefore, consumption of the electronic document by the user 20, the document reader function 32 of the user device 16 detects a triggering event for one of the triggers for the electronic document (step 110). In response to detecting the triggering event for one of the triggers defined for the electronic document, the document reader function 32 of the user device 16 performs the callback action for the trigger (step 112). The callback action may be performed substantially immediately upon detection of the triggering event or performed after a delay, which may be defined by the trigger. As discussed above, the callback action may be sending a text message or e-mail message to a defined entity, establishing voice communication with a defined entity, providing a poll or questions to the user 20 and returning answers provided by the user 20 to a defined entity via a text message or e-mail message, or the like.

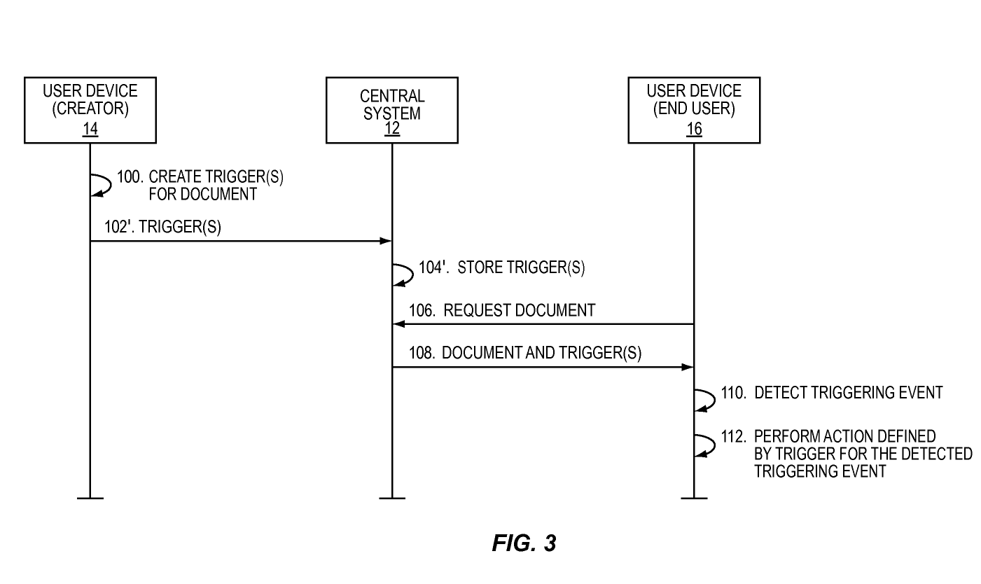

FIG. 3 illustrates the operation of the system 10 of FIG. 1 according to another embodiment of the present disclosure. The process illustrated in FIG. 3 is substantially the same as described above with respect to FIG. 2. However, in this embodiment, steps 102 and 104 of FIG. 2 are replaced with steps 102′ and 104′. Specifically, in this embodiment, the electronic document is already hosted by the central system 12. As such, after creating the one or more triggers for the electronic document (step 100), rather than sending both the electronic document and the one or more triggers for the electronic document to the document server 24 of the central system 12, only the one or more triggers for the electronic document are sent to the document server 24 of the central system 12 (step 102′). The central system 12 then stores the one or more triggers for the electronic document (step 104′). The one or more triggers may be stored by inserting the one or more triggers into the electronic document or may be stored separately from the electronic document depending on the particular implementation. From this point, steps 106-112 proceed as discussed above with respect to FIG. 2.

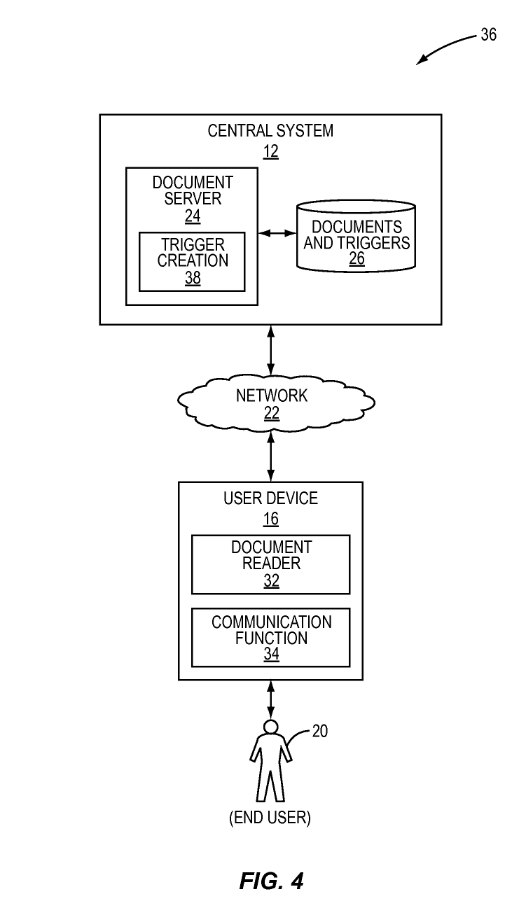

FIG. 4 illustrates a system 36 for providing callback triggers for electronic documents according to another embodiment of the present disclosure. As illustrated, the system 36 includes the central system 12 and the user device 16 communicatively coupled by the network 22. In this embodiment, the document server 24 includes a trigger creation function 38. The trigger creation function 38 operates to create triggers for at least some of the electronic documents stored in the collection of documents and triggers 26. The trigger creation function 38 may create the triggers using a manual process based on input from an operator of the central system 12 or using an automatic process, in much the same manner as described above with respect to FIGS. 2 and 3.

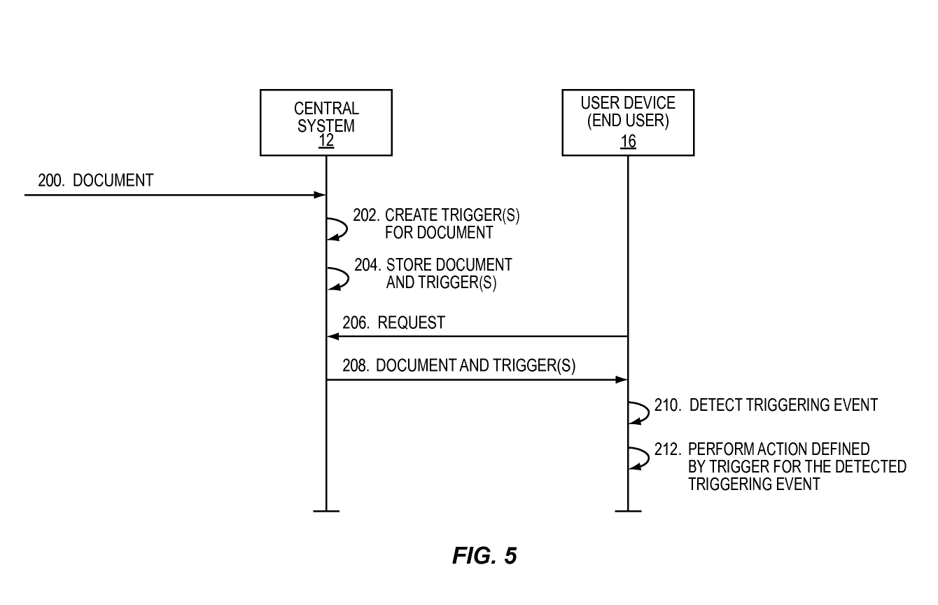

FIG. 5 illustrates the operation of the system 36 of FIG. 4 according to one embodiment of the present disclosure. As illustrated, first, the central system 12 receives an electronic document from some source (step 200). The source of the electronic document may be, for example, another user device such as the user device 14 (FIG. 1). At some point after receiving the electronic document, the trigger creation function 38 of the central system 12 creates one or more triggers for the electronic document (step 202).

As discussed above, each trigger created for the electronic document defines a triggering event and a callback action to be performed in response to the triggering event. Preferably, the callback action for a trigger is one or more of the following: sending a text message to a defined entity, sending an e-mail message to a defined entity, establishing voice communication with a defined entity, and polling the end user or asking the end user a number of questions and returning answers provided by the end user to a defined entity. Note that, as discussed above, the callback action may provide information to the defined entity in receipt of the resulting communication regarding the end user, the trigger or triggering event, the electronic document, or any combination thereof. Note that, as discussed above, in some embodiments, the callback action may be utilized as a form of rights management.

The triggering event for a trigger may be defined in different manners depending on the particular trigger. In one embodiment, the triggering event for a trigger is defined by a trigger point and a user action. The trigger point may be a particular area of the electronic document such as a chapter, a section, a heading, a paragraph, a sentence, a word, a phrase, a picture, a figure, or any combination thereof. Alternatively, the trigger point may be defined by one or more semantic criteria such that a point within the electronic document satisfying the one or more semantic criteria is identified as the trigger point for the trigger. The user action may be scrolling past the trigger point; tapping, clicking, or otherwise selecting the trigger point; dwelling on the trigger point for a defined amount of time; gazing at the trigger point; or the like. In another embodiment, the triggering event for a trigger may be highlighting or otherwise selecting text, a picture, a figure, or any combination thereof within the electronic document by the end user. Further, as discussed above, the triggering event for each of the one or more triggers for the electronic document may be further defined by one or more additional criteria. The one or more additional criteria may include, for example, one or more time or date criteria, one or more user-based criteria, one or more location-based criteria, or any combination thereof. In this manner, the triggers can be customized for users, locations, and/or dates or times.

The manner in which the one or more triggers are created for the electronic document may vary depending on the particular implementation. In general, the one or more triggers may be created manually or automatically. More specifically, in one embodiment, an operator (i.e., a person) of the central system 12 provides input to the trigger creation function 38 of the central system 12 to manually define the one or more triggers for the electronic document. Note that while in this embodiment the user 18 creates one or more triggers for a specific electronic document, in another embodiment, the user 18 may create one or more triggers to be applied to all electronic documents or defined groups of electronic documents.

In another embodiment, the trigger creation function 38 of the central system 12 generates one or more triggers for the electronic document automatically based on one or more rules. The one or more rules include one or more system-defined rules, one or more user-defined rules, or both. The one or more system-defined rules are not defined by the operator of the central system 12 whereas the one or more user-defined rules are defined by the operator of the central system 12. The one or more rules enable the trigger creation function 38 to identify points in the electronic document for which triggers are to be created and define callback actions for the triggers. For example, the one or more rules may indicate that a trigger is to be inserted for each section of the electronic document, that the triggers are to be activated as an end user scrolls past the corresponding sections, and that an e-mail message is to be sent to the user 18 each time the triggers are activated. The e-mail message may notify the user 18 that an end user or a particular end user has just read or is currently reading the corresponding section of the electronic document. As another example, the one or more rules may indicate that a trigger is to be inserted for an occurrence or for each occurrence of a specified word or phrase within the electronic document, that the trigger(s) are to be activated when an end user clicks, taps, or otherwise selects the specified word or phrase, and that a mobile telecommunications call be established between the end user and a specified entity when the trigger is activated. As a final example, the one or more rules may include a semantic rule indicating that a trigger is to be inserted at an occurrence or at each occurrence of content within the electronic document satisfying one or more semantic criteria. For instance, the specified semantic criteria may include a criterion of “action” such that the electronic document is processed to identify words, sentences, paragraphs, or the like in which substantial action is taking place (e.g., an action scene) and insert triggers at those points to send text messages to the creator of the electronic document upon activation of those triggers. Similarly, the specified semantic criteria may include a criterion of “Cuban Cuisine” such that the electronic document is processed to identify words, sentences, paragraphs, or the like related to Cuban cuisine and insert triggers to contact a reservation service if an end user gazes upon those points in the electronic document for more than a specified amount of time.

Once the triggers are created for the electronic document, the document server 24 of the central system 12 stores the electronic document and the one or more triggers for the electronic document in the collection of documents and triggers 26 (step 204). Some time thereafter, the document server 24 of the central system 12 receives a request for the electronic document from the user device 16 (step 206). In response, the document server 24 of the central system 12 returns the electronic document and the one or more triggers for the electronic document to the user device 16 (step 208). Note that, in some embodiments, the triggers for the electronic document may include triggers having triggering events that are further defined by additional criteria such as one or more user-based criteria regarding the end user, one or more location-based criteria regarding the location of the end user, one or more time or date based criteria, or any combination thereof. In this case, the document server 24 of the central system 12 may return all triggers for the electronic document to the user device 16 or return only those triggers relevant to the user 20, the location of the user 20, and/or the current time or date. For instance, the one or more triggers for the electronic document may include different sets of triggers for different groups of users, which may be defined by the user-based criteria for the corresponding triggering events. As such, the document server 24 of the central system 12 may identify the set of triggers for the electronic document for a group of users of which the user 20 is a member and return one or more of the identified set of triggers to the user device 16. In a similar manner, sets of triggers may be defined for different geographic areas, different times of the day, and/or different ranges of dates, where the one or more triggers returned to the user device 16 are triggers from the relevant sets of triggers for the electronic document. In another embodiment, the user 20 may subscribe to triggers for one or more identified users, and the document server 24 of the central system 12 may return triggers for the electronic document created by those identified users.

User preferences of the user 20 may be used to filter triggers for the electronic document. The filtering may occur at the document server 24 or at the user device 16. For example, the user 20 may define user preferences indicating that the user 20 does not permit defined types of triggers such as triggers having undesired triggering events or undesired callback actions (e.g., callback action to an undesired entity). Also note that, in some embodiments, the user 20 may be enabled to opt out of triggers by, for example, paying certain fees.

The document reader function 32 of the user device 16 then presents the electronic document to the user 20 (which is also referred to as the end user). During presentation of the electronic document to the user 20 and, therefore, consumption of the electronic document by the user 20, the document reader function 32 of the user device 16 detects a triggering event (step 210). In response to detecting the triggering event for one of the triggers defined for the electronic document, the document reader function 32 of the user device 16 performs the callback action for the trigger (step 212). The callback action may be performed substantially immediately upon detection of the triggering event or performed after a delay, which may be defined by the trigger. As discussed above, the callback action may be sending a text message or e-mail to a defined entity, establishing voice communication with a defined entity, providing a poll or questions to the user 20 and returning answers provided by the user 20 to a defined entity via a text message or e-mail message, or the like.

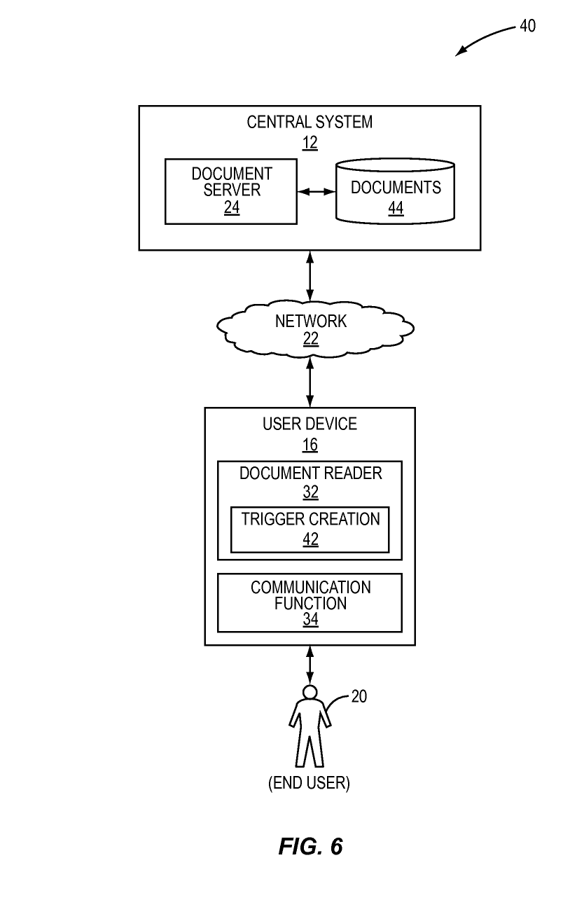

FIG. 6 illustrates a system 40 for providing callback triggers for electronic documents according to another embodiment of the present disclosure. As illustrated, the system 40 includes the central system 12 and the user device 16 communicatively coupled by the network 22. In this embodiment, the document reader function 32 of the user device 16 includes a trigger creation function 42. The trigger creation function 42 operates to create triggers for electronic documents at the user device 16. The trigger creation function 42 creates the triggers using an automatic process based on one or more system-defined rules, one or more user-defined rules, or both. Further, in this embodiment, the central system 12 includes a collection of documents 44, rather than the collection of documents and triggers 26 (FIGS. 1 and 4).

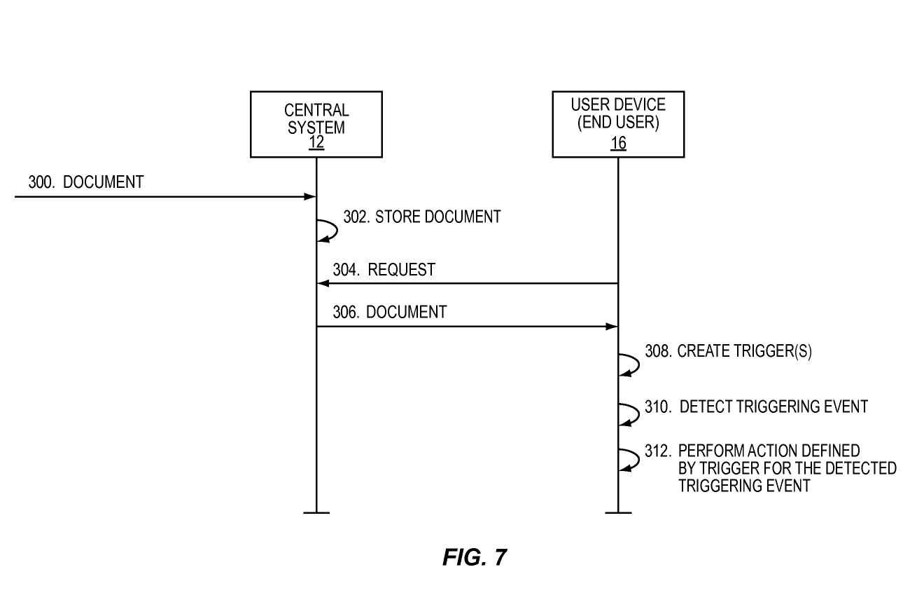

FIG. 7 illustrates the operation of the system 40 of FIG. 6 according to one embodiment of the present disclosure. As illustrated, first, the central system 12 receives an electronic document from some source (step 300). The source of the electronic document may be, for example, another user device such as the user device 14 (FIG. 1). Upon receiving the electronic document, the document server 24 of the central system 12 stores the electronic document in the collection of documents 44 (step 302). Some time thereafter, the document server 24 of the central system 12 receives a request for the electronic document from the user device 16 and returns the electronic document to the user device 16 (steps 304 and 306).

At the user device 16, sometime either before consumption of the electronic document by the user 20 or during consumption of the electronic document by the user 20, the trigger creation function 42 of the document reader function 32 creates one or more triggers for the electronic document (step 308). As discussed above, each trigger created for the electronic document defines a triggering event and a callback action to be performed in response to the triggering event. Preferably, the callback action for a trigger is one or more of the following: sending a text message to a defined entity, sending an e-mail message to a defined entity, establishing voice communication with a defined entity, and polling the end user or asking the end user a number of questions and returning answers provided by the end user to a defined entity. Note that, as discussed above, the callback action may provide information to the defined entity in receipt of the resulting communication regarding the end user, the trigger or triggering event, the electronic document, or any combination thereof. Note that, as discussed above, in some embodiments, the callback action may be utilized as a form of rights management.

The triggering event for a trigger may be defined in different manners depending on the particular trigger. In one embodiment, the triggering event for a trigger is defined by a trigger point and a user action. The trigger point may be a particular area of the electronic document such as a chapter, a section, a heading, a paragraph, a sentence, a word, a phrase, a picture, a figure, or any combination thereof. Alternatively, the trigger point may be defined by one or more semantic criteria such that a point within the electronic document satisfying the one or more semantic criteria is identified as the trigger point for the trigger. The user action may be scrolling past the trigger point; tapping, clicking, or otherwise selecting the trigger point; dwelling on the trigger point for a defined amount of time; gazing at the trigger point; or the like. In another embodiment, the triggering event for a trigger may be highlighting or otherwise selecting text, a picture, a figure, or any combination thereof within the electronic document by the end user. Further, as discussed above, the triggering event for each of the one or more triggers for the electronic document may be further defined by one or more additional criteria. The one or more additional criteria may include, for example, one or more time or date criteria, one or more user-based criteria, one or more location-based criteria, or any combination thereof. In this manner, the triggers can be customized for users, locations, and/or dates or times.

In this embodiment, the trigger creation function 42 operates to create the one or more triggers using an automatic process based on one or more system-defined rules, one or more user-defined rules, or both. The one or more system-defined rules are not defined by the user 20 of the user device 16, whereas the one or more user-defined rules are defined by the user 20 of the user device 16. The one or more rules enable the trigger creation function 42 to identify points in the electronic document for which triggers are to be created and define callback actions for the triggers. Note that, in addition to the types of user-based and system-based rules discussed above, the one or more rules may include rules based on historic information regarding past activities of the user 20. The historic information may include information regarding electronic documents previously consumed by the user 20 (e.g., topics discussed in the electronic documents previously read by the user 20), information regarding actions taken by the user 20 after consuming or while consuming previous electronic documents (e.g., phone numbers of users or entities called or otherwise communicated with by the user 20 while reading previous electronic documents), past purchases made by the user 20, or the like, or any combination thereof. As an example, a rule may be defined that states if the user 20 has previously contacted a reservation service while reading or soon after reading electronic documents that discuss a particular type of cuisine or a type of cuisine in general, then a trigger may be created for the electronic document if the electronic document discusses the particular type of cuisine or a type of cuisine in general. Thus, the trigger created based on this rule may be define a triggering event such as dwelling on a paragraph discussing cuisine for a defined amount of time, where the callback action for the trigger is calling the reservation service.

During presentation of the electronic document to the user 20 and, therefore, consumption of the electronic document by the user 20, the document reader function 32 of the user device 16 detects a triggering event (step 310). In response to detecting the triggering event for one of the triggers defined for the electronic document, the document reader function 32 of the user device 16 performs the callback action for the trigger (step 312). The callback action may be performed substantially immediately upon detection of the triggering event or performed after a delay, which may be defined by the trigger. As discussed above, the callback action may be sending a text message or e-mail to a defined entity, establishing voice communication with a defined entity, providing a poll or questions to the user 20 and returning answers provided by the user 20 to a defined entity via a text message or e-mail message, or the like.

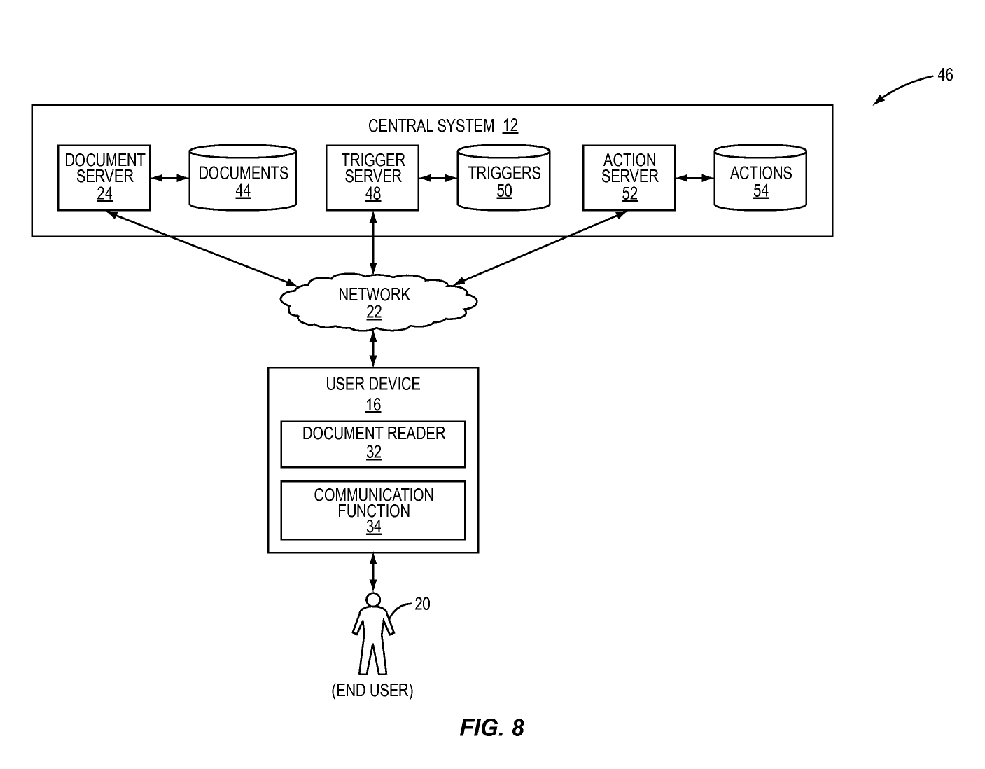

FIG. 8 illustrates a system 46 for providing callback triggers for electronic documents according to another embodiment of the present disclosure. As illustrated, the system 46 includes the central system 12 communicatively coupled to the user device 16 via the network 22. However, in this embodiment, the central system 12 includes the document server 24 associated with the collection of documents 44, a trigger server 48 associated with a collection of triggers 50 for at least some of the electronic documents included in the collection of documents 44, and an action server 52 associated with a collection of actions 54 including callback actions for at least some of the triggers included in the collection of triggers 50. Note that while the document server 24, the trigger server 48, and the action server 52 are all implemented on the central system 12 in this embodiment, alternatively, the trigger server 48 along with the associated collection of triggers 50 and the action server 52 along with the collection of actions 54 may be implemented on separate systems (e.g., physical server(s) separate from physical server(s) hosting the document server 24).

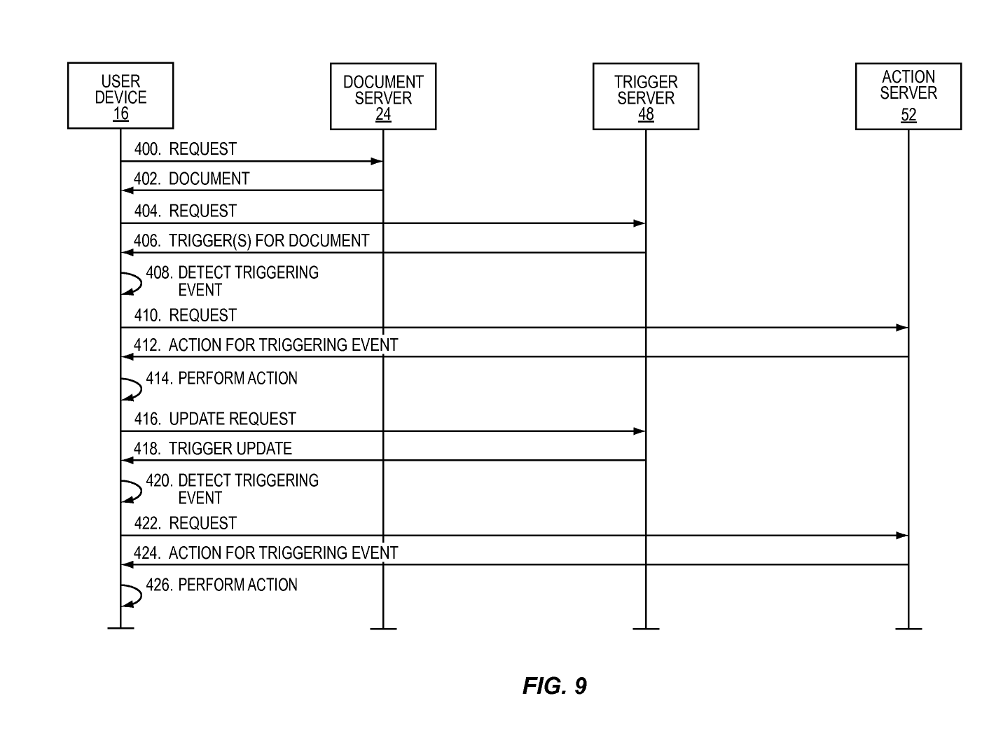

FIG. 9 illustrates the operation of the system 46 of FIG. 8 according to one embodiment of the present disclosure. As illustrated, the document server 24 receives a request for an electronic document from the user device 16 (step 400). In response, the document server 24 obtains the electronic document from the collection of documents 44 and returns the electronic document to the user device 16 (step 402). The user device 16 also sends a request to the trigger server 48 for triggers for the electronic document (step 404). In one embodiment, a Uniform Resource Identifier (URI) such as a Uniform Resource Locator (URL) for the trigger server 48 or, alternatively, a URI such as a URL for one or more triggers for the electronic document at the trigger server 48 are provided to the user device 16 by the document server 24. The URI for the trigger server 48 or the URI for the one or more triggers for the electronic document may be embedded within the electronic document (e.g., included in headers of the digital file for the electronic document or embedded in the body of the electronic document) or provided separately from the electronic document. Alternatively, the user device 16 may have pre-existing knowledge of the trigger server 48 and, as such, there would be no need for obtaining the URI of the trigger server 48 or the one or more triggers for the electronic document hosted by the trigger server 48 from the document server 24.

In response to the request from the user device 16, the trigger server 48 obtains one or more triggers for the electronic document from the collection of triggers 50 and returns the one or more triggers to the user device 16 (step 406). The one or more triggers for the electronic document may be constant, such that the one or more triggers for the electronic document do not vary from one user to another, from one end user location to another, over time, or the like. However, in another embodiment, the one or more triggers for the electronic document may be dynamic. More specifically, the one or more triggers for the electronic document may be customized for the user 20 of the user device 16, customized based on a location of the user 20 of the user device 16, customized based on the time of day at which the request is received from the user device 16, customized based on the date on which the request is received from the user device 16, customized based on current events, or the like, or any combination thereof.

With respect to personalizing the one or more triggers for the electronic document, the one or more triggers for the electronic document may be customized for the user 20 based on information regarding the user 20 such as, for example, demographic information (e.g., age, gender, marital status, ethnicity, home address, education level, or the like), identification of the user 20 as a member of a predefined group, social network relationships, or the like. More specifically, in one embodiment, different sets of triggers for the electronic document may be created for a number of user groups. For example, the user groups may be age groups such that one set of triggers for the electronic document is created for each age group. Then, the one or more triggers returned for the user 20 are the set of triggers created for the age group of which the user 20 is included. The information regarding the user 20 may also identify a pre-defined group to which the user 20 belongs. For example, an English teacher may create a set of triggers for a particular electronic document assigned for reading by his or her students. If the user 20 is one of the students, the one or more triggers returned to the user 20 are the triggers created by his or her English teacher for the electronic document.

With respect to customization of the one or more triggers based on the location of the user 20, the one or more triggers for the electronic document may vary based on location of the end user. More specifically, in one embodiment, different sets of triggers for the electronic document are created for each of a number of predetermined geographic areas. The one or more triggers for the electronic document returned to the user 20 are then the one or more triggers in the set of triggers for the electronic document created for the geographic area in which the user 20 is located.

The one or more triggers returned to the user 20 may be customized based on the time of day during which the request is received from the user device 16. More specifically, in one embodiment, different sets of triggers for the electronic document may be defined for a number of time periods during the day. The one or more triggers for the electronic document returned to the user 20 are then the one or more triggers in the set of triggers defined for the electronic document for the time of day at which the request was sent from the user device 16. Similarly, the one or more triggers for the electronic document returned to the user device 16 may be customized based on the date on which the request is received from the user device 16. More specifically, different sets of triggers for the electronic document may be defined for a number of ranges of dates. The one or more triggers for the electronic document returned to the user device 16 may then be the one or more triggers in the set of triggers defined for the range of dates including the date on which the request is made.

Regarding customization based on current events, the triggers stored in the collection of triggers 50 for the electronic document may vary dynamically based on current events. More specifically, the electronic document may be analyzed via an automatic process to identify triggers based on current events. This process is periodically or otherwise repeated over time to dynamically update the triggers for the electronic document based on current events. For example, a rule used to automatically process the electronic document to create triggers for the electronic document may state that triggers are to be created for points in the electronic document that discuss a person currently appearing in the news such as, for example, a political figure discussed in an article on the main page of CNN's website. The callback action for such triggers may be sending a text message or e-mail message to a defined entity indicating that a user, or the particular end user, has read an electronic document that discusses the corresponding political figure.

During presentation of the electronic document to the user 20 and, therefore, consumption of the electronic document by the user 20, the document reader function 32 of the user device 16 detects a triggering event (step 408). In this embodiment, in response to detecting the triggering event for one of the triggers defined for the electronic document, the document reader function 32 of the user device 16 sends a request to the action server 52 for a callback action to be performed in response to the triggering event (step 410). Note that, in an alternative embodiment, the triggers for the electronic document may already define the callback actions for the triggers. In another alternative embodiment, the callback action may be requested from the action server 52 prior to detection of the triggering event. However, in this embodiment, the user device 16 obtains the callback action to be performed from the action server 52 after the corresponding triggering event has been detected. A URI for the action server 52 or a URI for the particular callback action may be defined within the trigger. Alternatively, the user device 16, and specifically the document reader function 32 of the user device 16, may already have the URI of the action server 52.

In response to the request, the action server 52 obtains the callback action for the trigger activated by the triggering event at the user device 16 and returns the callback action to the user device 16 (step 412). The user device 16 then performs the callback action for the trigger (step 414). As discussed above, the callback action may be sending a text message or e-mail to a defined entity, establishing voice communication with a defined entity, providing a poll or questions to the user 20 and returning answers provided by the user 20 to a defined entity via a text message or e-mail message, or the like.

In this embodiment, at some point after performing the callback action, the document reader function 32 of the user device 16 sends an update request to the trigger server 48 (step 416). The update request may be sent periodically by the document reader function 32 at some system-defined or user-defined time interval, sent upon detection of a location change of the user device 16, sent in response to the occurrence of a defined user action (e.g., rating the electronic document), sent in response to reaching a defined point in the electronic document (e.g., a new chapter or section of the electronic document or the next page in the electronic document), or as otherwise desired. Alternatively, the update request may be sent each time the user 20 opens the electronic document. In response, the trigger server 48 provides an update for the triggers for the electronic document to the user device 16 (step 418). The update may include a new set of one or more triggers to replace the previous triggers sent to the user device 16 for the electronic document or may include only changes to the previous triggers to sent to the user device 16 for the electronic document (e.g., new triggers, changes to previous triggers, and/or notice to remove deleted triggers). By updating the triggers, the triggers for the electronic document can be dynamically changed over time. The changes may occur to changes relating to the user 20 of the user device 16, changes in the location of the user device 16, changes in date or time, changes in current events, or any other changes made to the triggers such as, for instance, changes made by the creator of the triggers for the electronic document.

During the same presentation of the electronic document to the user 20 or a subsequent presentation of the electronic document to the user 20, the document reader function 32 of the user device 16 detects a triggering event (step 420). Again, in this embodiment, in response to detecting the triggering event for one of the triggers defined for the electronic document, the document reader function 32 of the user device 16 sends a request to the action server 52 for a callback action to be performed in response to the triggering event (step 422). In response to the request, the action server 52 obtains the callback action for the trigger activated by the triggering event at the user device 16 and returns the callback action to the user device 16 (step 424). Note that, by using the action server 52, the callback actions for the corresponding triggers may be dynamically changed over time. For example, the callback actions may be changed by a creator of the corresponding triggers. As another example, the callback actions may dynamically change based on changes to information regarding the user 20, changes in the location of the user 20, changes in the date or time, changes in current events, or any combination thereof. The user device 16 then performs the callback action for the trigger (step 426). The callback action may be performed substantially immediately upon detection of the triggering event or performed after a delay, which may be defined by the trigger.

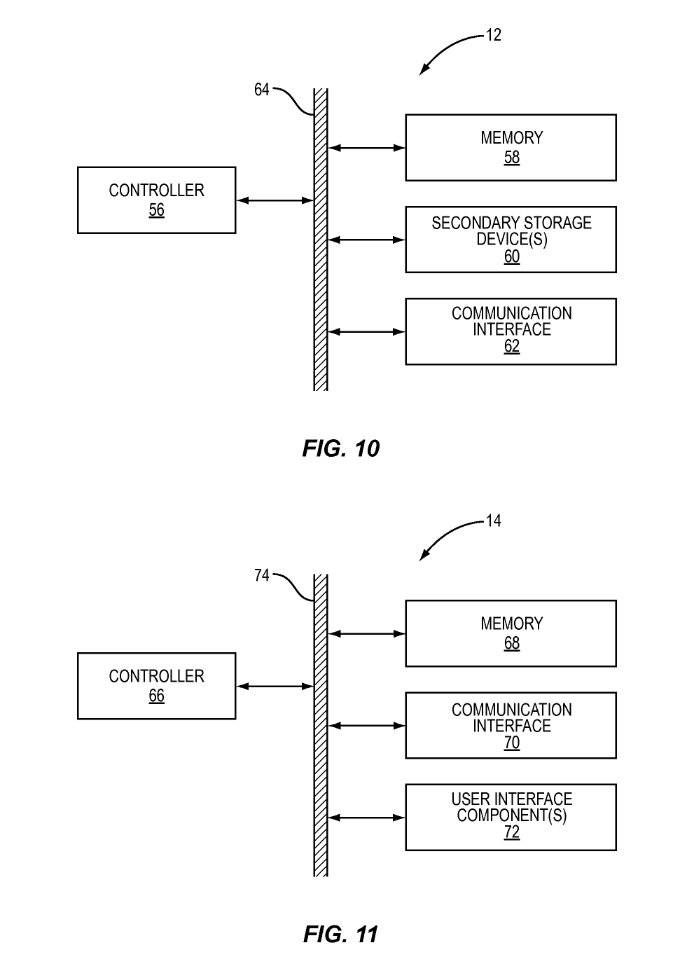

FIG. 10 is a block diagram of the central system 12 of FIGS. 1-9 according to one embodiment of the present disclosure. As illustrated, the central system 12 includes a controller 56 connected to memory 58, one or more secondary storage devices 60, and a communication interface 62 by a bus 64 or similar mechanism. The controller 56 is a microprocessor, digital Application Specific Integrated Circuit (ASIC), Field Programmable Gate Array (FPGA), or the like. In this embodiment, the controller 56 is a microprocessor, and, depending on the particular embodiment, either the document server 24 is implemented in software and stored in the memory 58 for execution by the controller 56 (FIGS. 1-7), or the document server 24, the trigger server 48, and the action server 52 are implemented in software and stored in the memory 58 for execution by the controller 56 (FIGS. 8 and 9). Further, depending on the particular embodiment, the collection of documents and triggers 26 (FIGS. 1-5), the collection of documents 44 (FIGS. 6 and 7), or the collection of documents 44, the collection of triggers 50, and the collection of actions 54 (FIGS. 8 and 9) are stored in the one or more secondary storage devices 60. The secondary storage devices 60 are digital data storage devices such as, for example, one or more hard disk drives. The communication interface 62 is a wired or wireless communication interface that communicatively couples the central system 12 to the network 22 (FIGS. 1, 4, 6, and 8). For example, the communication interface 62 may be an Ethernet interface, local wireless interface such as a wireless interface operating according to one of the suite of IEEE 802.11 standards, or the like.

FIG. 11 is a block diagram of the user device 14 of FIGS. 1-3 according to one embodiment of the present disclosure. As illustrated, the user device 14 includes a controller 66 connected to memory 68, a communication interface 70, and one or more user interface components 72 by a bus 74 or similar mechanism. The controller 66 is a microprocessor, digital ASIC, FPGA, or the like. In this embodiment, the controller 66 is a microprocessor, and the trigger creation function 28 (FIG. 1) is implemented in software and stored in the memory 68 for execution by the controller 66. The communication interface 70 is a wired or wireless communication interface that communicatively couples the user device 14 to the network 22 (FIG. 1). For example, the communication interface 70 may be an Ethernet interface, local wireless interface such as a wireless interface operating according to one of the suite of IEEE 802.11 standards, a mobile communications interface such as a cellular telecommunications interface, or the like. The communication function 30 (FIG. 1) may be implemented software stored in the memory 68 and executed by the controller 66 and/or as a component of the communication interface 70. The one or more user interface components 72 include, for example, a touchscreen, a display, one or more user input components (e.g., a keypad), a speaker, or the like, or any combination thereof.

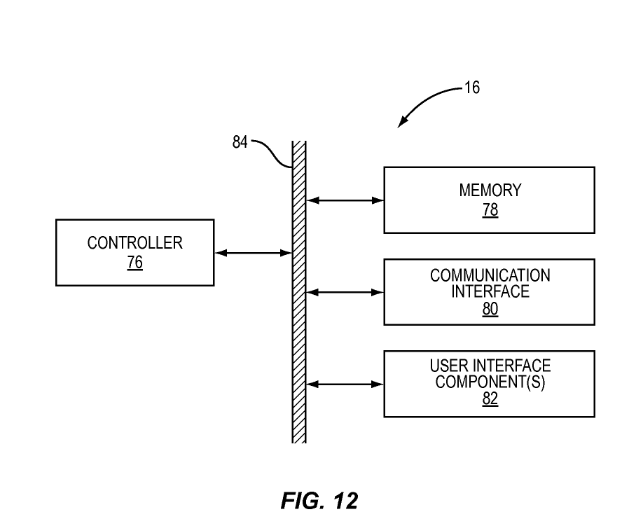

FIG. 12 is a block diagram of the user device 16 of FIGS. 1-9 according to one embodiment of the present disclosure. As illustrated, the user device 16 includes a controller 76 connected to memory 78, a communication interface 80, and one or more user interface components 82 by a bus 84 or similar mechanism. The controller 76 is a microprocessor, digital ASIC, FPGA, or the like. In this embodiment, the controller 76 is a microprocessor, and the document reader function 32 (FIGS. 1, 4, 6, and 8) is implemented in software and stored in the memory 78 for execution by the controller 76. The communication interface 80 is a wired or wireless communication interface that communicatively couples the user device 16 to the network 22 (FIGS. 1, 4, 6, and 8). For example, the communication interface 80 may be an Ethernet interface, local wireless interface such as a wireless interface operating according to one of the suite of IEEE 802.11 standards, a mobile communications interface such as a cellular telecommunications interface, or the like. The communication function 34 (FIGS. 1, 4, 6, and 8) may be implemented software stored in the memory 78 and executed by the controller 76 and/or as a component of the communication interface 80. The one or more user interface components 82 include, for example, a touchscreen, a display, one or more user input components (e.g., a keypad), a speaker, or the like, or any combination thereof.

Those skilled in the art will recognize improvements and modifications to the embodiments of the present invention. All such improvements and modifications are considered within the scope of the concepts disclosed herein and the claims that follow.

What is claimed is:

1. A method of operating a user device comprising:
obtaining an electronic document and a semantic trigger for the electronic document, wherein the semantic trigger defines one or more semantic criteria, a user action, and a callback action to be performed in response to detection of the user action at a point in the electronic document that satisfies the one or more semantic criteria;
detecting an occurrence of the user action at a point in the electronic document that satisfies the one or more semantic criteria during consumption of the electronic document by a user of the user device as a triggering event for the semantic trigger; and
in response to detecting the triggering event for the semantic trigger, performing the callback action defined by the semantic trigger.

2. The method of claim 1 further comprising identifying one or more points in the electronic document satisfying the one or more semantic criteria prior to consumption of the electronic document by the user.

3. The method of claim 1 further comprising identifying one or more points in the electronic document satisfying the one or more semantic criteria during consumption of the electronic document by the user.

4. The method of claim 1 wherein the user action is one of a group consisting of: selection of an area of the electronic document, scrolling, dwelling for more than a defined amount of time, and gazing.

5. The method of claim 1 wherein the semantic trigger further defines one or more additional criteria that must be satisfied for detection of the triggering event for the semantic trigger.

6. The method of claim 5 wherein the one or more additional criteria comprise at least one of a group consisting of: one or more user-based criteria, one or more location-based criteria, one or more time-based criteria, one or more date-based criteria, and one or more current-event-based criteria.

7. The method of claim 1 wherein the callback action for the semantic trigger comprises one of a group consisting of: sending a text message to a defined entity, sending an e-mail to a defined entity, establishing voice communication with a defined entity, and polling the user or asking the user a number of questions and returning answers provided by the user to a defined entity.

8. The method of claim 1 further comprising updating the semantic trigger for the electronic document over time.

9. The method of claim 1 wherein obtaining the electronic document and the semantic trigger for the electronic document comprises obtaining the electronic document and the semantic trigger for the electronic document from a remote document server.

10. The method of claim 1 wherein obtaining the electronic document and the semantic trigger for the electronic document comprises:
obtaining the electronic document from a document server; and
obtaining the semantic trigger for the electronic document from a trigger server.

11. The method of claim 10 wherein a Uniform Resource Identifier (URI) is provided in association with the electronic document for at least one of a group consisting of: the trigger server and the semantic trigger for the electronic document at the trigger server.

12. The method of claim 10 wherein obtaining the electronic document and the semantic trigger for the electronic document further comprises obtaining the callback action for the semantic trigger from an action server.

13. The method of claim 12 wherein the semantic trigger defines at least one of a group consisting of: a Uniform Resource Identifier (URI) of the action server or a URI of the callback action for the semantic trigger at the action server.

14. The method of claim 1 wherein the semantic trigger for the electronic document is created by another user via a manual process.

15. The method of claim 1 wherein the semantic trigger for the electronic document is created by a remote device or server via an automatic process.

16. A user device comprising:
a communication interface communicative coupling the user device to a network; and
a control system associated with the communication interface and adapted to:
obtain an electronic document and a semantic trigger for the electronic document, wherein the semantic trigger defines one or more semantic criteria, a user action, and a callback action to be performed in response to detection of the user action at a point in the electronic document that satisfies the one or more semantic criteria;
detect an occurrence of the user action at a point in the electronic document that satisfies the one or more semantic criteria during consumption of the electronic document by a user of the user device as a triggering event for the semantic trigger; and
in response to detecting the triggering event for the semantic trigger, perform the callback action defined by the semantic trigger.

17. The user device of claim 16 wherein the control system is further adapted to identify one or more points in the electronic document satisfying the one or more semantic criteria prior to consumption of the electronic document by the user.

18. The user device of claim 16 wherein the control system is further adapted to identify one or more points in the electronic document satisfying the one or more semantic criteria during consumption of the electronic document by the user.

19. A computer readable medium storing software for instructing a control system of a user device to:
obtain an electronic document and a semantic trigger for the electronic document, wherein the semantic trigger defines one or more semantic criteria, a user action, and a callback action to be performed in response to detection of the user action at a point in the electronic document that satisfies the one or more semantic criteria;
detect an occurrence of the user action at a point in the electronic document that satisfies the one or more semantic criteria during consumption of the electronic document by a user of the user device as a triggering event for the semantic trigger; and
in response to detecting the triggering event for the semantic trigger, perform the callback action defined by the semantic trigger.

20. The computer readable medium of claim 19 wherein the software further instructs the control system of the user device to identify one or more points in the electronic document satisfying the one or more semantic criteria prior to consumption of the electronic document by the user.

21. The computer readable medium of claim 19 wherein the software further instructs the control system of the user device to identify one or more points in the electronic document satisfying the one or more semantic criteria during consumption of the electronic document by the user.
